(19) United States
(12) Patent Application Publication
(10) Pub. No.: US 2020/0305368 A1
(43) Pub. Date: Oct. 1, 2020

(54) Hydroponic Growing System

(71) Applicant: Matthew Ross, St. Augustine, FL (US)

(72) Inventor: Matthew Ross, St. Augustine, FL (US)

(21) Appl. No.: 16/371,018

(22) Filed: Mar. 31, 2019

(51) Int. Cl. A01G 31/02; A01G 24/00

(52) U.S. Cl. CPC A01G 31/02; A01G 2031/006; A01G 24/00

(57) ABSTRACT

Hydroponic growing systems are gaining in popularity because of the relative ease of use and these systems eliminate the traditional problems with growing plants in earth: insects and fungus, among other issues. Hydroponic growing systems do not depend on soil and therefore the issue of insects and bugs and/or other harmful elements to plants are largely avoided. The device in this case circulates water through a closed system on a timed basis; the primary issue for this system is accommodating the right growing conditions for the plant. This issue is addressed by using substrate to promote healthy plant growth.

### FIELD OF THE INVENTION

This invention relates to the cultivation and growing of plants in a hydroponic system. Hydroponic systems use water as opposed to soil for the cultivation and growing of plants. In this case, the system will be a closed loop system. One of the issues of any hydroponic system is to maintain appropriate growing conditions by introducing the appropriate amount of water without saturating the root system of the plants. Another issue is a safety issue; because these systems use water the system should be designed so that water outside the container should be kept to a minimum. The plastic tubing that is used to circulate water may also contain nutrients; the system can be expanded simply and efficiently by the additional pieces of tubing.

The seeds for the different plants are placed in growth cups that are inserted into the growing tubes under which water that is circulated through an irrigation tube in each growing tube. A filler or substrate material is placed in the growing tubes to ensure that a certain amount of water is maintained without saturating the root structure of the plants. With this system a healthy plant can be produced.

### PRIOR ART

There are many other prior art references to hydroponic growing systems. A representative example of this can be found in Graber U.S. Pat. No. 9,968,039. Graber is a vertical system using a series of cups into which the plant is placed and water is circulated throughout the system.

Another example which deals with the addition of nutrients in a hydroponic system for the plants is Tucker, U.S. Pat. No. 6,314,676. This uses a filter into which microorganisms are inserted to help assist with the cultivation and growing of plants.

Another example can be found at Yano, which is also a hydroponic cultivation apparatus. In the Yano application, the root structure is saturated in water within its self-contained environment. In the current application, the root systems are not saturated; they are left damp but not saturated. An excessive amount of water around the roots of the plant yields an unhealthy plant.

Another example can be found at Miyabe, which is a hydroponic cultivation method using a series of steps including a first plant cultivation apparatus, using a first liquid fertilizer and a second plant cultivation apparatus, which uses a second liquid fertilizer. In the current application there are no individual steps or stages. The Miyabe specifically refers to the addition of fertilizer as opposed to an actual hydroponic system.

Another example can be found at Roy, U.S. Pat. No. 7,143,544, in which the hydroponic growing unit is self-contained and circular. The water will circulate throughout the structure and a series of planting blocks in which the plants are mounted on the support are arranged in a circle. A water member is associated with each support main to provide water, pumped from the base of the top of each block mount on the support beams. The system in Roy does not provide a means to expand the system.

While each of the references contain ideas that teach in the area of hydroponic growing systems, none of the applications specifically incorporate all the features which are anticipated or taught by this application.

### BRIEF SUMMARY OF THE INVENTION

A self-contained reservoir of water is placed below a series of tubes; if additional water is needed, the water is added through the feeder cups. It is anticipated that because this is a closed system that the water losses will be minimal. The tubes are likely to be plastic. A pump and associated piping is placed in the reservoir. Nutrients may also be placed in the water to promote plant growth.

The water is circulated from the reservoir through a pair of feeder tubes, which is part of a two tube structure: a growing tube and a feeder tube. The growing tube is placed on the top of the reservoir. On the top of the growing tubes are a plurality of holes into which growing cups or a grow medium are placed. The seed is placed in rockwool or other type of material and placed in the growing cup. The holes may be of different sizes and shapes to accommodate different types of plants.

A separate irrigation tube is placed within the growing tube. Perforations are placed in the irrigation tube to carry the nutrients to the plants in the growing tubes. A substrate material is placed in the interior of the growing tubes. The substrate will retain water for the growth of the plant but will not allow saturation of the root system of the plant. As water is circulated within the feeder tubes, the water will moisten the substrate material. The water that is circulated through the feeder tubes is on a timed schedule. Grates are placed in the interior of the growing tubes to prevent the substrate from entering the area of the pump, which is located in the self-contained reservoir and causing interruption of the pumping while at the same time preventing the root structure of the plants from also entering the pump area.

A means to drain the reservoir as well as water level indicator level to quickly determine the level of water in the reservoir are also provided. An air pump and air stone may also be used to provide appropriate levels of carbon monoxide\air in the water that is circulated through the system.

The internal piping also allows for the addition of accessories such as drippers and other common hydroponic delivery system options. Additionally, the system can be easily expanded by attaching additional pieces of piping either horizontally or vertically.

The substrate that is used is placed within the growth tube piping and is used to support root growth and root health. Different types of substrate may be used depending on the needs of the plant.

Additionally, for the plants that require height, such as tomatoes and other vining plants, portable clip-ons can be installed on the piping to provide towers for the growing plants.

### BRIEF DESCRIPTION OF THE DRAWINGS

FIG. 1 is an isometric view of the outer surface of the hydroponic growing system.

FIG. 2 is an isometric view of the reservoir of the hydroponic growing system.

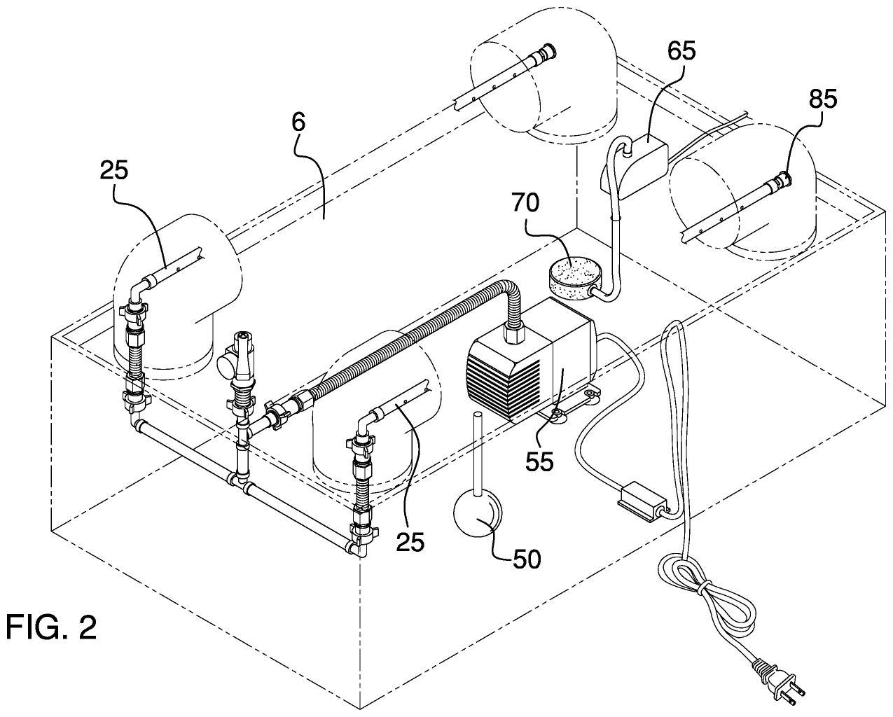

FIG. 3 is a side cross-sectional view of both sections of the hydroponic growing system.

FIG. 4 is a front cross-sectional view of the reservoir of the hydroponic growing system.

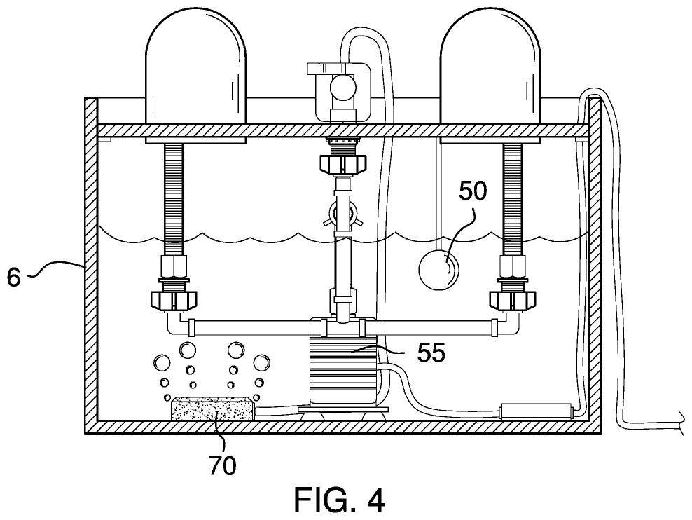

FIG. 5 is a detail cross-sectional view of the growing and irrigation tube of the hydroponic growing system.

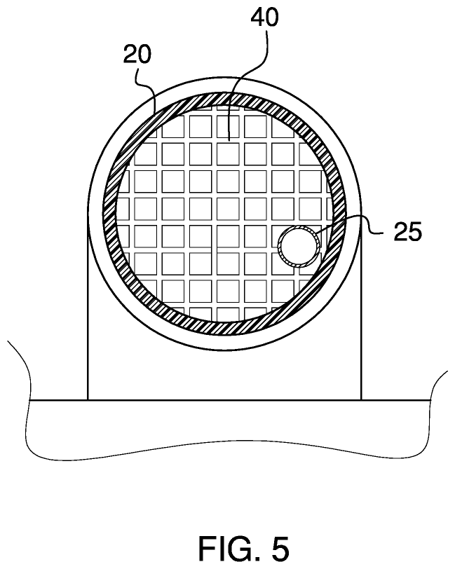

FIG. 6 is a detailed view of the vertical expansion means.

FIG. 7 is an exploded view showing the system expansion.

### NUMBERING REFERENCES

5—Device
6—Self-Contained Reservoir/Watertight Vessel
10—Growth Tube
15—Growth Cup Openings
20—Growth Cups
25—Irrigation Tubes
30—Perforations on irrigation tubes
35—Substrate material
40—Grate
45—Drain
50—Water level indicator
55—Pump
60—Expansion Piece
65—Air Pump
70—Air Stone
75—Flex pipe
80—Threaded fitting
85—Cap
90—Straight coupler

### DETAILED DESCRIPTION OF THE EMBODIMENTS

The device is a self-contained hydroponic growing system. Because this system is self-contained the water losses in the system should be minimal. Hydroponic growing systems use only water to grow plants. With this type of system, issues that are related to growing plants are not present. Some of these issues include the issue of insects and finding the right salinity and pH of the soil. While these issues may not be present in hydroponic systems, the person operating a hydroponic system must worry about ideal growing conditions including finding the correct pH of the water as well as regulating the amount of water that is in contact with the root structure of the plants.

The device has several components among others: a self-contained reservoir 6, a pair of growth tubes 10, a pair of irrigation tubes 25, a drain 45, a water level indicator 50 a pump 55 and associated piping. An air stone 70 is also included to infuse oxygen into the water that is circulated through the system.

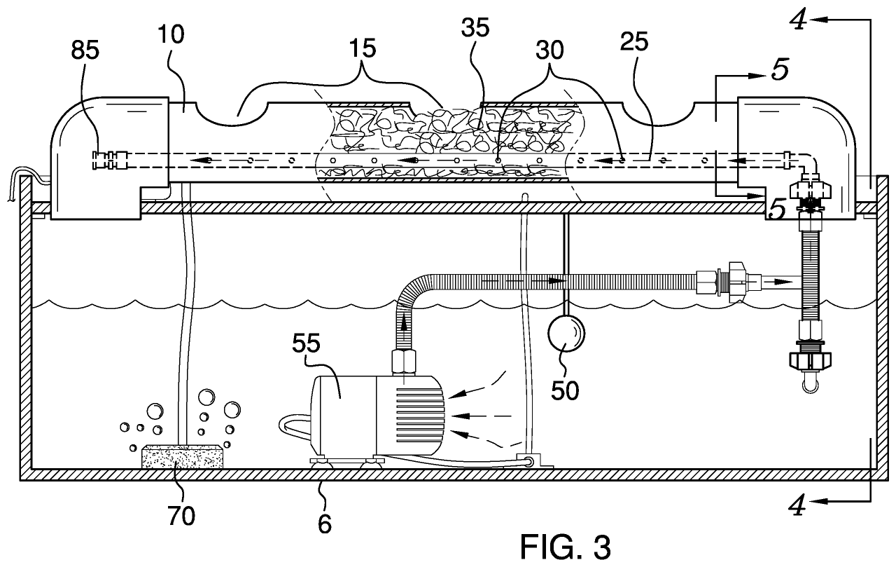

A quantity of water is placed in the reservoir 6 and is pumped through a pair of hollow, perforated irrigation tubes 25 in a closed loop such as depicted in FIG. 3. The feeder tubes 25 are placed inside the pair of growth tubes 10. Water is pumped through the feeder tubes using a timer (not depicted). The frequency of watering and length of each watering period may vary with the type of plant that is being grown. A plurality of perforations 30 are placed in the irrigation tubes to ensure that each of the plants receives the appropriate amount of water to promote even growth among the plants.

A plurality of openings 15 are placed on the top of the growth tubes 10. These openings may be different sizes or shapes depending on the plant that is being grown. A growth cup 20 is placed in the opening on the growth tubes. The seed of the plant is placed in the growth tube and placed in the opening. In order to ensure that the seed does not leave the growth cup material such as rockwool may be used to encapsulate the seed. No specific means to house the seed is claimed in this application.

Substrate material 35 is placed in the interior of the growth tubes 10. As the water is circulated through the system, some of the water will be left on the substrate material. This will leave the substrate material damp and adds area for the roots to grow into in a healthy manner however it can drain to ensure its not too damp to affect the healthy growth of the plant. Different materials may be used depending on the specific needs of the plant.

On either end of each of the growth tubes is a grate 40, that has a plurality of holes into which water from the system can freely move back and forth within the growth tubes and the rest of the system. Perforations on the irrigation tubes 30 are also included to insure even water distribution to the plants. The circulation of water will be controlled by a timer. Additionally, the nutrient, which may be added to water is also dependent upon the plant to be grown.

The water level should be maintained within an ideal range and a water level indicator 50 can easily reveal the amount of water in the reservoir and quickly alert the user regarding the level of water in the reservoir. Additionally, a drain 45 can be used to drain some or all of the water contained in the reservoir. No specific water level indicator or drain is claimed as part of this invention.

The grates 40 are placed in the interior of the growth tube to prevent the substrate material and/or the root structure of the plant from traveling down the piping to interfere with the operation of the pump. No specific grate is contemplated but the grates should allow the free flow of water in the system while at the same time blocking the substrate and root structures from interfering the operation of the pump or clogging the lines.

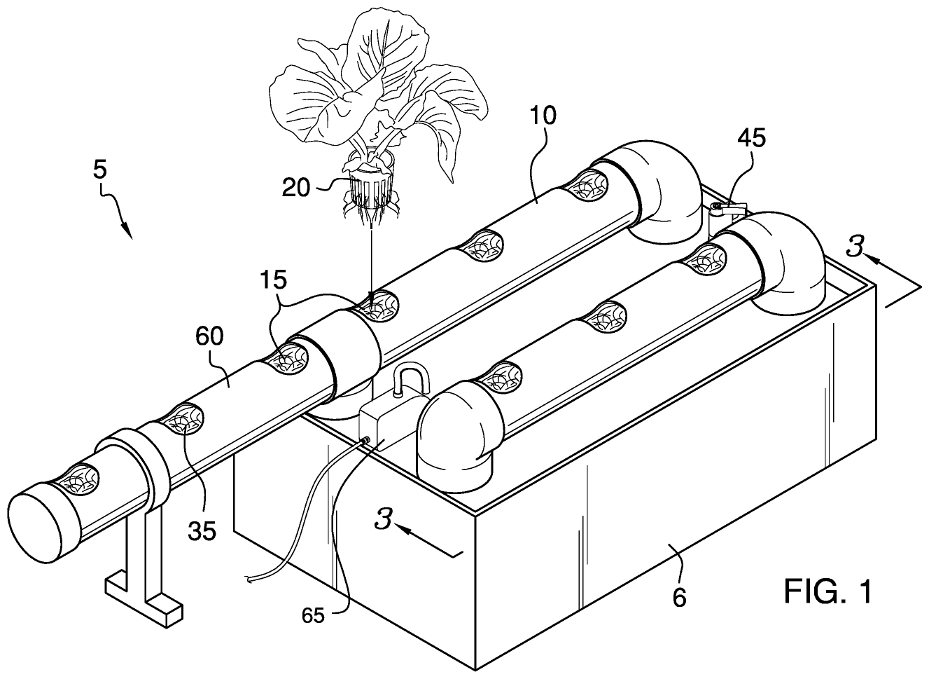

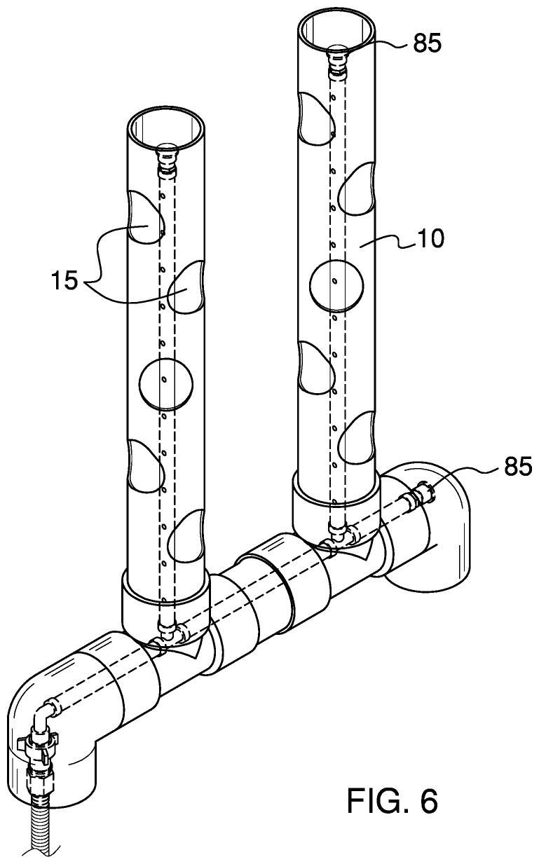

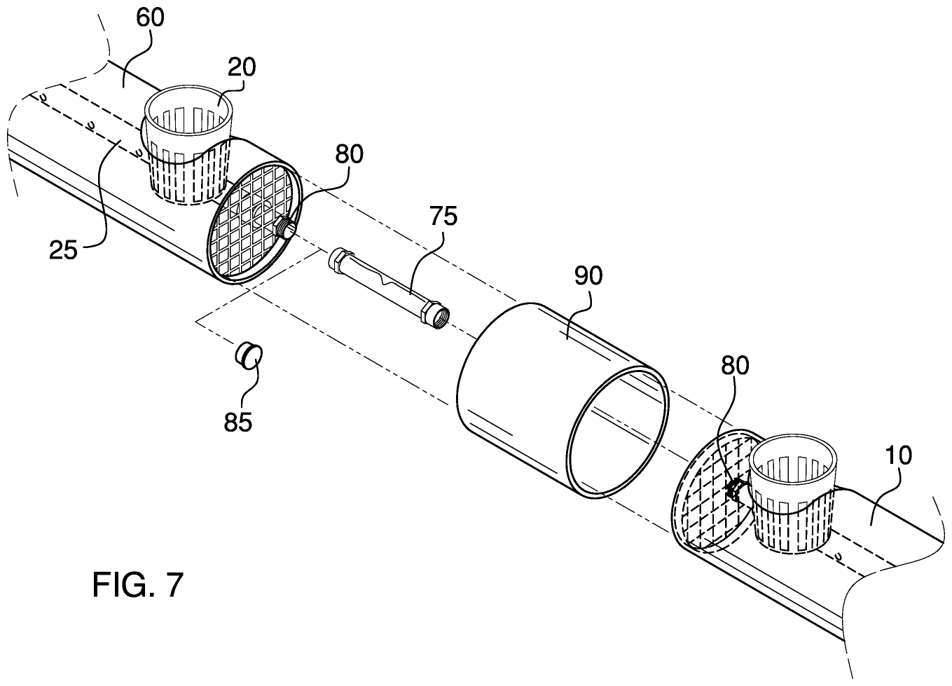

The system may also be expandable using a series of plastic and silicon expansion pieces 60. This expansion may occur horizontally as well as vertically as depicted in FIG. 1, FIG. 6 and FIG. 7. At the end of the flexible feeder tube a threaded fitting 80 is placed in order to join another feeder tube to another section of feeder tube using a flexible pipe 75. A straight coupler 90 is used to connect the original growing tube to the additional growing tube. A cap 85 is used to seal the end of the irrigation tube.

Additionally, with some plants who are “climbing plants” such as tomatoes, clipon pieces (not depicted) onto which the climbing plant will adhere will be attached to the cylindrical growth tubes. These clip-ons, which are not meant to be a permanent part of the device can easily be removed if needed by the consumer. Additionally, if the expansion of the system is horizontal support mechanisms may be included as depicted in FIG. 6.

1. The inventor claims a hydroponic growing system, which is comprised of:
a. a reservoir;
wherein the reservoir is self-contained;
wherein the reservoir holds a predetermined amount of water;
wherein the top of the reservoir can be removed;
b. grow tubes;
wherein the grow tubes run parallel to each other on the top surface of the reservoir;
c. a plurality of growth cup openings;
d. growth cups;
wherein the seed of a plant is placed in the growth cup;
e. irrigation tubes
wherein the irrigation tubes are placed within the growth tubes;
wherein a plurality of perforations are placed on the feeder tubes;
f. a substrate material;
wherein the substrate material is placed in the interior of the growth tube;
g. a pair of grates;
wherein a pair of grates are placed on the ends of the interior of the growth tubes;
h. a drain;
i. a water level indicator;
j. a pump;
wherein the pump circulates water through the system;
wherein associated piping is connected to the pump to circulate water in the system;
k. a means to expand the system;
l. an airstone.

2. The hydroponic growing system as described in claim 1 wherein the openings of the growth tube are different sizes.

3. The hydroponic growing system as described in claim 1 wherein the substrate material may vary depending on the type of plant.

4. The hydroponic growing system as described in claim 1 wherein the grow tubes can be horizontal.

5. The hydroponic growing system as described in claim 1 wherein the grow tubes can be vertical.
